(19) United States
(12) Patent Application Publication
(10) Pub. No.: US 2022/0284301 A1
(43) Pub. Date: Sep. 8, 2022

(54) MACHINE LEARNED ANOMALY DETECTION

(71) Applicant: Robert Bosch GmbH, Stuttgart (DE)

(72) Inventors: Chen Qiu, Sindelfingen (DE); Maja Rita Rudolph, Tuebingen (DE); Tino Pfrommer, Stuttgart (DE)

(21) Appl. No.: 17/651,917

(22) Filed: Feb. 22, 2022

(30) Foreign Application Priority Data
Mar. 8, 2021 (DE) 10 2021 202 189.1

(51) Int. Cl. G06N 3/08; G06K 9/62

(52) U.S. Cl. CPC G06N 3/084; G06K 9/6257

(57) ABSTRACT

A computer-implemented method and system for training an anomaly detector to distinguish outlier data from inlier data on which the anomaly detector is trained. The anomaly detector comprises a set of learnable data transformations and a learnable feature extractor. The set of learnable data transformations and the learnable feature extractor are jointly trained based on a trained objective, which training objective comprises a function serving as anomaly scoring function which may also be used at test time to determine the anomaly score of test data samples. Evaluation results show that the anomaly detector is well-applicable to detect anomalies in non-image data, e.g., in data timeseries and in tabular data, and straightforward to apply at test time.

### CROSS REFERENCE

The present application claims the benefit under 35 U.S.C. § 119 of German Patent Application No. DE 10 2021 202 189.1 filed on Mar. 8, 2021, which is expressly incorporated herein by reference in its entirety.

### FIELD

The present invention relates to a system and computer-implemented method for training an anomaly detector to distinguish outlier data from inlier data on which the anomaly detector is trained. The present invention further relates to a system and computer-implemented of using a trained anomaly detector to distinguish outlier data from inlier data on which the anomaly detector is trained. The present invention further relates to a computer-readable medium comprising transitory or non-transitory data representing an anomaly detector, and to a computer-readable medium comprising transitory or non-transitory data representing instructions for a processor system to perform the computer-implemented method.

### BACKGROUND INFORMATION

In many practical applications, there is a need to detect anomalies in data. For example, an anomaly in medical data may indicate a pathological condition, with one specific example being that an anomaly in an electrocardiogram of the heart may indicate a heart condition. Another example is anomaly detection in security data, where an anomaly may indicate a security breach. Such anomaly detection may in general be considered as a one-class classification problem where the goal is to identify out-of-distribution (abnormal or outlier) data instances from the data instances of the normal (in-distribution or inlier).

It is conventional to design anomaly detectors manually, e.g., based on heuristics. However, it may be cumbersome to determine the appropriate heuristics, and the resulting anomaly detectors may be limited in performance, i.e., in their detection accuracy.

It is conventional to design anomaly detectors using on machine learning, which may in the following also be referred to as ‘trainable’ or ‘learnable’ anomaly detectors, or as ‘trained’ or ‘learned’ anomaly detectors after their training. Such type of anomaly detectors promise improved performance compared to anomaly detectors which are based on manual heuristics. Deep learning-based approaches to anomaly detection are especially promising since deep learning has resulted in breakthroughs in various other application areas.

However, it is difficult to train an anomaly detector in a supervised way, since anomalies may occur rarely in various types of data; it may thus be cumbersome to have to manually detect and label such occurrences in such data. An example is the detection of an engine failure in sensor data; engine failure in modern engines is very rare, but it may still be desirable to be able to reliably detect various types of failures, including types of failures which have previously not yet occurred or of which no sensor data is available.

To address such problems, so-called self-supervised anomaly detection has been developed. For example, [1] considers the problem of anomaly detection in images and presents a detection technique which may be briefly described as follows. Given a sample of images, all known to belong to a “normal” class (e.g., dogs), a deep neural model is trained to detect out-of-distribution images (i.e., non-dog objects). In particular, a multi-class model is trained to discriminate between dozens of geometric transformations applied on all the given images. The auxiliary expertise learned by the model generates feature detectors that effectively identify, at test time, anomalous images based on the SoftMax activation statistics of the model when applied on transformed images.

Self-supervised anomaly detection of the type described in [1] Golan & El-Yaniv, “Deep Anomaly Detection Using Geometric Transformations”, https://arxiv.org/abs/1805.10917, has led to drastic improvements in detection accuracy of anomalies in image data.

### SUMMARY

The techniques described in [1] and others work well for image data. However, it would be desirable for self-supervised anomaly detection to also works well for other types of data, such as time-sequential data, tabular data, graph data, etc. For example, one may wish to detect anomalies in DNA/RNA sequences, or in logging data of a sell-driving system, or in multi-model sensor data obtained in a manufacturing process, etc.

In accordance with a first aspect of the present invention, a computer-implemented method and corresponding system are provided, for training an anomaly detector to distinguish outlier data from inlier data on which the anomaly detector is trained. In accordance with a further aspect of the present invention, a computer-implemented method and corresponding system are provided, for using such a trained anomaly detector.

In accordance with a further aspect of the present invention, a computer-readable medium is provided, comprising instructions for causing a processor system to perform the computer-implemented method. In accordance with a further aspect of the present invention, a computer-readable medium is provided comprising data representing an anomaly detector as trained the present invention.

The above measures involve providing a trainable anomaly detector. In accordance with an example embodiment of the present invention, to train the anomaly detector, training data is provided comprising data samples. Such data samples may take various forms, including but not limited to timeseries of data, rows in tabular data, non-time sequential data sequences such as DNA/RNA sequences, etc. The anomaly detector to be trained comprises a set of data transformations. Each of these data transformations transforms a data sample into a transformed data sample. For example, when considering a data space X with input data samples D={x⁽ⁱ⁾˜X}ᵢ₌₁^{N}, there may be K data transformations [symbol] :={T₁, . . . , T_{K}|T_{K}:X→X}. The data transformations are learnable, in that each data transformation may be at least in part parameterized, with the parameters being learnable during the training. As such, characteristics of the data transformation to be applied to a data sample may be learned. The anomaly detector further comprises a feature extractor. The feature extraction by the feature extractor is learnable, in that the feature extraction may be at least in part parameterized, with the parameters being learnable during the training. As such, the feature detector may be learned which type of features to extract. The feature space may also be referred to as an embedding space, e.g., Z, while the feature extractor may be represented as an encoder f from the data space X to the embedding space Z, e.g., as f_{ϕ}(⋅):X→Z with ϕ representing the parameters of the encoder.

The architecture of the anomaly detector may be such that the set of learnable data transformations is applied to an input data sample, both during training and at test time (e.g., after training, when using the anomaly detector). This yields a set of transformed data samples, with each transformed data sample being generated by a respective learn(able) (-ed) data transformation. The feature extractor may be applied to each transformed data sample, yielding a set of feature representations, one for each transformed data sample. In addition, the feature extractor may be applied to the input data sample, yielding a further feature representation. By such feature extraction, feature representations of the input and transformed data samples are made available.

In accordance with an example embodiment of the present invention, during training, the set of learnable data transformations and the learnable feature extractor may be jointly trained on the training data. Here, the term ‘jointly’ may refer to the parameters of both the set of learnable data transformation and of the learnable feature extractor being optimized during the training, for example using a gradient descent-type of optimization. As is conventional, such an optimization may seek to optimize a training objective. In accordance with the disclosed measures, the training objective may be defined as a function of the feature representations generated by the feature extractor. In other words, the training objective may be evaluated by evaluating a function, with the feature presentations being arguments to that function. In particular, the training objective may seek to jointly increase a) a similarity between the feature representation of the respective transformed data sample and the feature representation of the input data sample, and b) a dissimilarity between the feature representation of the respective transformed data sample and the feature representations of other transformed data samples generated from the input data sample. Effectively, the training objective may reward similarity of each transformed data sample to the input data sample and may reward mutual dissimilarity between the transformed data sample amongst themselves. Such similarity may be expressed in various ways, for example as a cosine similarity in the feature space.

The above measures are based on the following insights: self-supervised learning of anomaly detection may require data augmentation to define so-called auxiliary tasks for the learning. For image data, such data augmentation is intuitive and well-explored (e.g., rotation, cropping, flipping, blurring). However, a reason that self-supervised anomaly detection is not as effective on other types of data is that it is unclear which data transformations to use. The above measures essentially involve providing an anomaly detector in which the data transformations are learnable and jointly trained with the feature extractor, instead of being handcrafted. This training of the data transformations is made possible by a training objective which is defined so that data transformations are learned that adhere to the so-called semantic and diversity requirements of self-supervised learning. The semantic requirement may be formulated as “the transformations should produce transformed data samples that share relevant semantic information with the original input data sample” while the diversity requirement may be formulated as “the transformations should produce diverse transformed representations of each input data sample”. The training objective is formulated to simultaneously express both requirements, by requiring similarity of the transformed data samples to the input data sample and by requiring dissimilarity amongst the transformed data samples. The training objective may thus, when expressed as a loss term, represent a so-called contrastive loss which promotes a trade-off between semantics and diversity. Namely, without semantics, i.e., without there being a dependence of the transformed data samples on the input data sample, an anomaly detector may not be able to decide whether a new data sample is normal or an anomaly, while without variability in the learned data transformations, the self-supervised learning goal is not met.

As will be elucidated elsewhere, the anomaly detector which is learned in the manner in accordance with the present invention is shown to yield significant improvements over the state-of-the-art in anomaly detection for various data types, including data timeseries and tabular data.

Optionally, the training objective comprises a function which is to be optimized, wherein the function defines sums of pairwise similarities between feature representations to quantify:
the similarity between the feature representation of each respective transformed data sample and the feature representation of the input data sample; and
the similarity between the feature representation of each respective transformed data sample and the feature representations of the other transformed data samples generated from the input data sample.

The joint requirement of similarity and dissimilarity between the respective data samples may be expressed as a function which defines sums of pairwise similarities between respective feature representations. Here, the requirement of dissimilarity between transformed data samples may be calculated on the basis of a similarity, with the similarity being a negative factor in the function. For example, the function may be defined as:

$${\sum }_{k = 1}^{K} log \frac{h ( {x}_{k} , x )}{h ( {x}_{k} , x ) + {\sum }_{l \neq k} h ( {x}_{k} , {x}_{i} )}$$

where x represents the input data sample, xₖ represents a transformed data sample k from the set of K learnable data transformations, xₗ represents another transformed data sample with l unequal to k, and function h quantifies a pairwise similarity. The above-described function may be maximized during the training, or when used with a negative sign as a loss function, minimized, so as to optimize the training objective.

Optionally, the function is an anomaly scoring function generating an anomaly score for use:
during the training and as part of the training objective, wherein the training objective seeks to maximize the anomaly score for the training data; and
when using the anomaly detector after the training, to generate an anomaly score for a data sample which is provided as input to the anomaly detector

The function expressing the joint requirement of similarity and dissimilarity between the respective data samples may provide a score as output, which score may inherently expresses whether a data sample which is input to the learned anomaly detector at test time represents an anomaly or not. For example, during training, the anomaly scoring function may be maximized, or when used with a negative sign as a loss function, minimized. After training, the anomaly scoring function is then expected to be high for normal data and low for abnormal data. Accordingly, the anomaly scoring function may be used to score data samples at test time and may be included in a data representation of the trained anomaly detector, i.e., may be part of the anomaly detector. Since the function may be evaluated using a single data sample as input, it is easy to evaluate at test time.

Optionally, a learnable data transformation comprises a neural network, wherein the neural network optionally comprises at least one of:
one or more feedforward layers;
one or more skip connections between layers;
one or more convolutional layers; and
a set of layers representing a transformer network.

Each learnable data transformation may thus comprise, or in some cases consist of, a neural network. The neural network may for example be a feedforward neural network which may allow feedforward transformations to be defined by parameterization such as Tₖ(x):=Mₖ(x), with Mₖ(⋅) representing the learnable data transformation, which may in some cases also be referred to as a learnable mask. In another example, the neural network may be a so-called residual neural network (ResNet) which comprises one or more skip connections between layers and which may allow residual-type of transformations to be defined by parameterization such as Tₖ(x):=Mₖ(x)+x. In another example, the neural network may be a so-called convolutional neural network (ConvNet), or a transformer network. In yet other examples, the neural network may be a combination of layers from the above-described network types, e.g., a combination of feedforward and transformer layers.

In this respect, it is noted that each learnable data transformation may have the same architecture, e.g., by comprising a same type of neural network and type of parameterization. However, in other examples, the architecture may differ between the learnable data transformations. For example, some neural networks may be feedforward neural networks while others may be residual neural networks. In yet other example, some of the data transformations of the anomaly detector may be non-trainable (or trainable but not trained during the training) data transformations. In such cases, the anomaly detector may comprise a mix of trainable and non-trainable (or non-trained) data transformations. It is further noted that a learnable data transformation may not need to comprise a neural network may instead comprise another learnable model, or in general any differentiable function with learnable parameters, e.g., neural architectures (feed forward, recurrent, convolutional, residual, transformers, combinations of these architectures), affine transformations, integral transformations with a kernel function, or a physical simulator.

Optionally, the neural network is configured to generate the transformed data sample in form of an element-wise multiplication of:
the input data sample, with
an output of a feedforward network part receiving the input data sample as input.

Such a neural network may allow multiplicative transformations to be defined by parameterization such as Tₖ(x):=Mₖ(x)⊙x, which multiplicative transformation may define a masking of the input data sample. Such a multiplicative transformation may be advantageous since it contributes to explainability of the trained anomaly detector. Namely, analysis of a mask may show which parts or aspects of an input data sample are highlighted by the mask (large values in the mask) and which parts or aspects are ignored (values close to 0 in the mask). In addition, the anomaly score may be defined as a sum over the k transformations, which allows comparison of how much each term contributes to the overall anomaly score; the mask that contributes most to the anomaly score may be analyzed as above to give the user an explanation of why a specific sample was flagged as an anomaly.

Optionally, the training data comprises a number of data timeseries as respective data samples, and wherein a learnable data transformation is configured to transform a data timeseries into a transformed data timeseries in accordance with its parameterization. The anomaly detector may thus be trained to be applied to data timeseries as data samples and may thus identify whether a data timeseries is considered normal or abnormal. This may for example allow an ECG recording to be classified as showing a heart condition, or a network log to be classified as showing a network intrusion, etc.

Optionally, the data timeseries is or comprises a timeseries of sensor data. Such sensor data may for example represent medical sensor readings, sensor readings obtained from a set of sensors used for monitoring a manufacturing process, etc.

Optionally, the training data comprises tabular data defining a set of attributes for a respective data sample, and wherein a learnable data transformation is configured to transform the set of attributes into a transformed set of attributes in accordance with its parameterization. The anomaly detector may be applied to tabular data, in which a data sample is defined by a set of attributes. Typically, in such tabular data, the columns may define attributes while the rows define value of the attributes for respective data samples, or vice versa (e.g., the function of columns and rows may be switched). Such tabular data is ubiquitous. For example, during the production of semiconductor wafers, various aspects of the production may be monitored by sensors, yielding for example different measured attributes of a wafer (e.g., a voltage measurement and a resistance measurement). Such different measured attributes may be formatted as ‘tabular data’ where each data sample corresponds to one wafer and the entries in the columns are the measurement values. By providing learnable data transformations which may transform a set of attributes into a transformed set of attributes, the data transformations may be applied to tabular data.

With continued reference to the use of the anomaly detector at test time, an anomaly scoring function may be evaluated as described elsewhere in this specification. Optionally, the anomaly score may be a scalar which may be thresholded to determine whether or not the test data sample represents an outlier with respect to the inlier data on which the anomaly detector is trained. Accordingly, by thresholding, a scalar anomaly score may be converted into one-class classification, e.g., normal or abnormal, which may be useful in various application areas, e.g., in quality monitoring of manufactured products.

It will be appreciated by those skilled in the art that two or more of the above-mentioned embodiments, implementations, and/or optional aspects of the present invention may be combined in any way deemed useful, in view of the disclosure herein.

Modifications and variations of any system, any computer-implemented method or any computer-readable medium, which correspond to the described modifications and variations of another one of said entities, can be carried out by a person skilled in the art on the basis of the present description.

### BRIEF DESCRIPTION OF THE DRAWINGS

These and other aspects of the present invention will be apparent from and elucidated further with reference to the embodiments described by way of example in the following description and with reference to the figures.

FIG. 1 shows a system in accordance with an example embodiment of the present invention, for training an anomaly detector to distinguish outlier data from inlier data on which the anomaly detector is trained, wherein the anomaly detector comprises a set of learnable data transformations and a learnable feature extractor, which set of learnable data transformations and learnable feature extractor are jointly trained;

FIG. 2 shows a method in accordance with an example embodiment of the present invention, for training an anomaly detector to distinguish outlier data from inlier data on which the anomaly detector is trained.

FIG. 3 illustrates the anomaly detector in accordance with the present invention being applied to a data sample during the training or at test time, wherein the data transformations output respective transformed data samples and the feature extractor outputs respective feature representations.

FIG. 4A shows a histogram of anomaly scores before training.

FIG. 4B shows a histogram of the anomaly scores after training.

FIG. 5 illustrates data transformations learned for spectrograms.

FIG. 6 shows AUC results on the SAD and NATOPS test sets for different anomaly detectors including the trained anomaly detector described in this specification in accordance with the present invention.

FIG. 7 shows a system for using a trained anomaly detector to distinguish outlier data from inlier data on which the anomaly detector is trained.

FIG. 8 shows a method for using a trained anomaly detector to distinguish outlier data from inlier data on which the anomaly detector is trained, in accordance with an example embodiment of the present invention.

FIG. 9 shows a computer-readable medium comprising data, in accordance with an example embodiment of the present invention.

It should be noted that the figures are purely diagrammatic and not drawn to scale. In the figures, elements which correspond to elements already described may have the same reference numerals.

### LIST OF REFERENCE NUMBERS AND ABBREVIATIONS

The following list of reference numbers is provided for facilitating the interpretation of the figures and shall not be construed as limiting the present invention.
AUC Area Under ROC Curve
ROC Receiver Operating Characteristic
100 system for training an anomaly detector
120 processor subsystem
140 data storage interface
150 data storage
152 training data
154 data representation of untrained anomaly detector
156 data representation of trained anomaly detector
200 method for training an anomaly detector
210 providing training data
220 providing data representation of anomaly detector
230 forward pass
240 using learnable data transformations to obtain transformed data
250 using learnable feature extractor to extract feature representations
260 evaluating training objective using feature representations
270 backward pass comprising adjustment of parameters
300 input data sample
310-314 learn(ed) (able) data transformation
320-324 transformed data sample
330 learn(ed) (able) feature extractor
340 feature representations of data samples
350 similarity between feature representations
360 dissimilarity between feature representations
400 histogram of anomaly score before training
410 anomaly score
420 density
430 normal data samples
440 abnormal data samples
450 histogram of anomaly score after training
500 AUC result for SAD test set
550 AUC result for NATOPS test set
600 system for anomaly detection
620 processor subsystem
640 data storage interface
650 data storage
652 test data
654 data representation of trained anomaly detector
660 sensor data interface
662 sensor data
670 actuator interface
672 control data
680 environment
685 sensor
690 actuator
700 method of anomaly detection
710 obtaining test data
720 obtaining data representation of trained anomaly detector
730 anomaly detection
740 using learned data transformations to obtain transformed data
750 using learned feature extractor to extract feature representations
760 evaluating anomaly score using anomaly scoring function
800 computer-readable medium
810 non-transitory data

### DETAILED DESCRIPTION OF EXAMPLE EMBODIMENTS

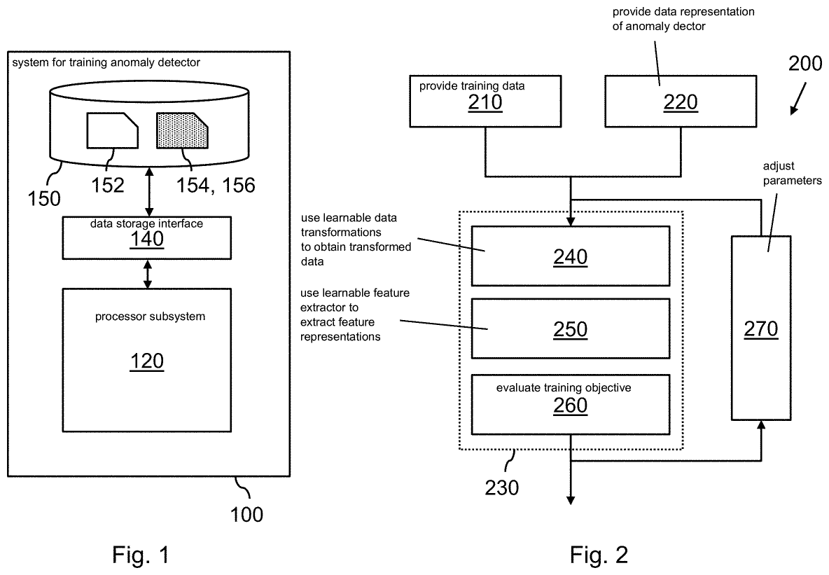

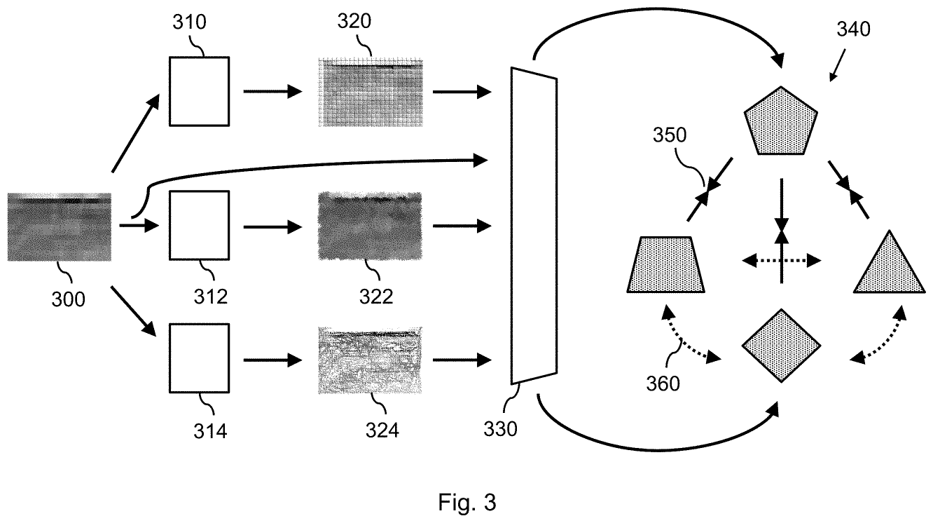

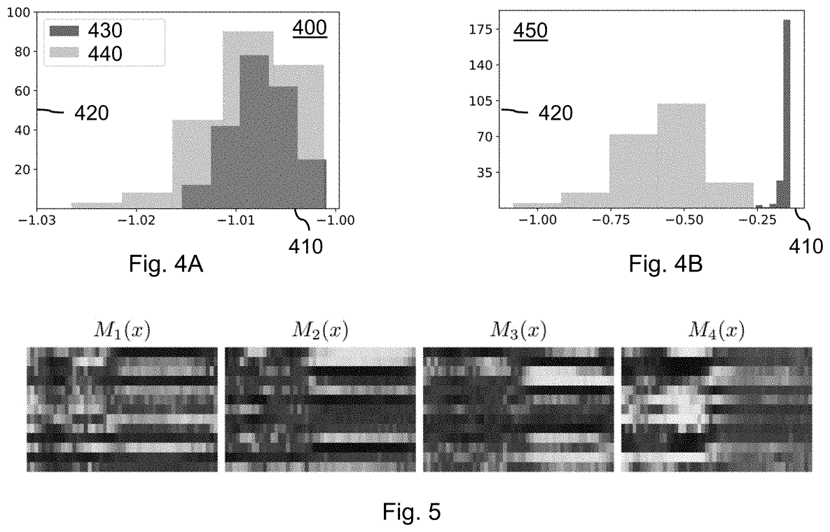

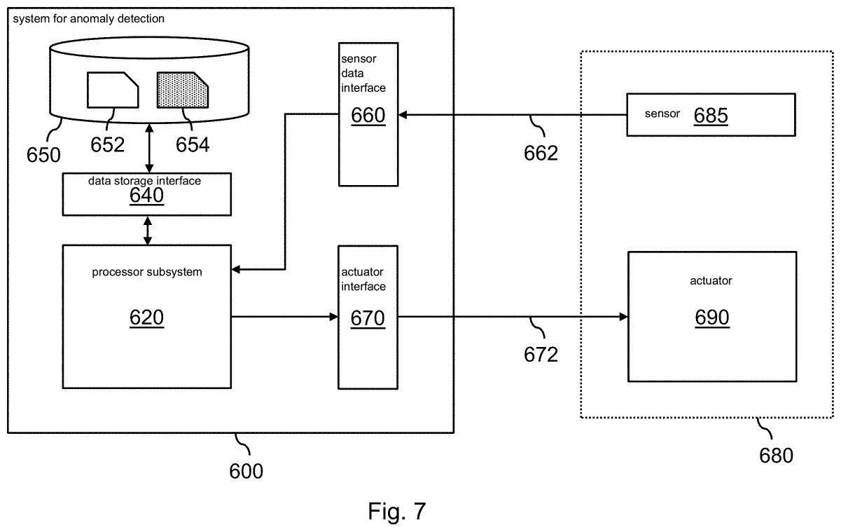

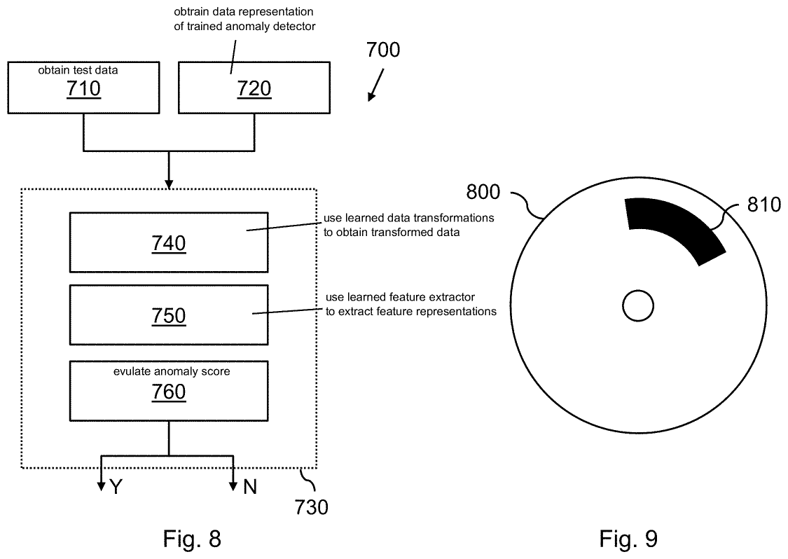

The following describes with reference to FIGS. 1 and 2 a system and computer-implemented method for training an anomaly detector which comprises a set of learnable data transformations and a learnable feature extractor, with reference to FIGS. 3 and 4 the application of the anomaly detector to an input data sample during training or at test time, with reference to FIGS. 4A-6 test results, and with reference to FIGS. 7 and 8 a system and computer-implemented method for using the trained anomaly detector. FIG. 9 shows a computer-readable medium used in embodiments of the present invention.

FIG. 1 shows a system 100 for training an anomaly detector to distinguish outlier data from training data on which the anomaly detector is trained and which may therefore be considered as inlier data. The system 100 may comprise an input interface subsystem for accessing training data 152 for the anomaly detector. For example, as illustrated in FIG. 1, the input interface subsystem may comprise or be constituted by a data storage interface 140 which may access the training data 152 from a data storage 150. For example, the data storage interface 140 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 150 may be an internal data storage of the system 100, such as a memory, hard drive or SSD, but also an external data storage, e.g., a network-accessible data storage. In some embodiments, the data storage 150 may further comprise a data representation 154 of an untrained version of the anomaly detector which may be accessed by the system 100 from the data storage 150. It will be appreciated, however, that the training data 152 and the data representation 154 of the untrained anomaly detector may also each be accessed from a different data storage, e.g., via different data storage interfaces. Each data storage interface may be of a type as is described above for the data storage interface 140. In other embodiments, the data representation 154 of the untrained anomaly detector may be internally generated by the system 100 on the basis of design parameters, and therefore may not explicitly be stored on the data storage 150.

The system 100 may further comprise a processor subsystem 120 which may be configured to, during operation of the system 100, train the anomaly detector to distinguish outlier data from inlier data as described elsewhere in this specification. For example, the training by the processor subsystem 120 may comprise executing an algorithm which optimizes parameters of the anomaly detector using a training objective.

The system 100 may further comprise an output interface for outputting a data representation 156 of the trained anomaly detector, this anomaly detector also being referred to as a machine ‘learned’ anomaly detector and the data also being referred to as trained anomaly detector data 156. For example, as also illustrated in FIG. 1, the output interface may be constituted by the data storage interface 140, with said interface being in these embodiments an input/output (‘IO’) interface via which the trained anomaly detector data 156 may be stored in the data storage 150. For example, the data representation 154 defining the ‘untrained’ anomaly detector may during or after the training be replaced, at least in part, by the data representation 156 of the trained anomaly detector, in that the parameters of the anomaly detector, such as parameters of the learnable data transformations and parameters of the learnable feature extractor, may be adapted to reflect the training on the training data 152. This is also illustrated in FIG. 1 by the reference numerals 154, 156 referring to the same data record on the data storage 150. In other embodiments, the data representation 156 of the trained anomaly detector may be stored separately from the data representation 154 defining the ‘untrained’ anomaly detector. In some embodiments, the output interface may be separate from the data storage interface 140 but may in general be of a type as described above for the data storage interface 140.

FIG. 2 shows a computer-implemented method 200 for training an anomaly detector. The method 200 may correspond to an operation of the system 100 of FIG. 1, but does not need to, in that it may also correspond to an operation of another type of system, apparatus, device or entity or in that it may correspond to steps of a computer program.

The method 200 is shown to comprise, in a step titled “PROVIDING TRAINING DATA”, providing 210 training data comprising data samples. The method 200 is further shown to comprise, in a step titled “PROVIDING DATA REPRESENTATION OF ANOMALY DETECTOR”, providing 220 an anomaly detector comprising a set of learnable data transformations, wherein each learnable data transformation is at least in part parameterized and configured to transform a data sample into a transformed data sample in accordance with its parameterization, and a learnable feature extractor, wherein the learnable feature extractor is at least in part parameterized and configured to generate a feature representation from a data sample or a transformed data sample in accordance with its parametrization. The method 200 is further shown to comprise jointly training the set of learnable data transformations and the learnable feature extractor using the training data and a training objective, wherein said joint training comprises, in a forward pass 230 of the training titled “FORWARD PASS” and in a step titled “USING LEARNABLE DATA TRANSFORMATIONS TO OBTAIN TRANSFORMED DATA”, using 240 the set of learnable data transformations, generating, using an input data sample from the training data as input, a set of transformed data samples as output, in a step titled “USING LEARNABLE FEATURE EXTRACTOR TO EXTRACT FEATURE REPRESENTATIONS”, using 250 the learnable feature extractor, generating respective feature representations of the transformed data samples and of the input data sample, and in a step titled “EVALUATING TRAINING OBJECTIVE USING FEATURE REPRESENTATIONS”, evaluating 260 the training objective using the feature representations, wherein the training objective is optimized by, for each transformed data sample, increasing a) a similarity between the feature representation of the respective transformed data sample and the feature representation of the input data sample, and b) a dissimilarity between the feature representation of the respective transformed data sample and the feature representations of other transformed data samples generated from the input data sample. The joint training further comprises, in a backward pass titled “BACKWARD PASS COMPRISING ADJUSTMENT OF PARAMETERS”, adjusting 270 parameters of the learnable data transformations and the learnable feature extractor in dependence on the training objective.

The following further describes the anomaly detector and various embodiments thereof. The anomaly detector as described in this specification may be based on the following: instead of manually designing data transformations to construct auxiliary prediction tasks that can be used for anomaly detection, the anomaly detector as described in this specification may comprise learnable data transformations. As detailed below, the training of the anomaly detector may involve learning a variety of data transformations such that the transformed data samples share semantic information with their untransformed form, while the different data transformations may be easily distinguishable from each other. The anomaly detector may, in addition to the learnable data transformations, also comprise a learnable feature extractor, which may also be referred to as an ‘encoder’. Both types of components may be jointly trained on a contrastive objective. The objective may have two purposes. During training, it may be used as (part of) a training objective which may be optimized during the training to determine the parameters of the feature extractor and the data transformations. At test time, the contrastive objective may be used to score each sample as either an inlier or an outlier/anomaly. The function expressing the contrastive objective may therefore elsewhere also be referred to as an anomaly scoring function.

The following provides a mathematical background of the learnable data transformations, the feature extractor and the contrastive objective. It is noted however that the anomaly detector and its components may also be implemented in various other ways, for example on the basis of analogous or alternative types of mathematical concepts.

Learnable Data Transformations. Consider a data space X with samples D={x⁽ⁱ⁾˜X}ᵢ₌₁^{N}. Consider K transformations [symbol] :={T₁, . . . , T_{K}|Tₖ:X→X}. These transformations may be learnable, in that they may be modeled by a parameterized function whose parameters may be accessible to, and thereby optimized by, an optimization algorithm, such as a gradient-based algorithm. The parameters of transformation Tₖ may be denoted by θₖ. In some embodiments, feed-forward neural networks may be used for Tₖ.

Deterministic Contrastive Loss (DCL). The contrastive objective may encourage each transformed sample xₖ=Tₖ(x) to be similar to its original sample x, while encouraging it to be dissimilar from other transformed versions of the same sample, xₗ=Tₗ(x) with l≠k. A similarity function of two (transformed) samples may be defined as:

h(xₖ,xₗ)=exp(sim(f_{ϕ}(Tₖ(x)),f_{ϕ}(Tₗ(x)))/τ), (1)

where τ denotes a temperature parameter, and wherein the similarity may be defined as the cosine similarity sim(z,z′):=z^{T}z′/∥z∥∥z′∥ in an embedding space Z (elsewhere also referred to as ‘feature space’). The encoder f_{ϕ}(⋅):X→Z may serve as a feature extractor. During training, the contrastive objective may be expressed by a loss function, also referred to as ‘contrastive loss’ which may be deterministic and may therefore also be referred to as ‘deterministic contrastive loss’, or in short DCL:

$$ℒ \text{:=} {𝔼}_{x \sim 𝒟} [ - {\sum }_{k = 1}^{K} log \frac{h ( {x}_{k} , x )}{h ( {x}_{k} , x ) + {\sum }_{l \neq k} h ( {x}_{k} , {x}_{i} )} ] . \qquad ( 2 )$$

The parameters of the anomaly detector θ=[ϕ, θ_{1:K}] may comprise the parameters ϕ of the encoder and the parameters θ_{1:K} of the learnable transformations. All parameters θ may be optimized jointly by minimizing the contrastive loss of equation 2.

FIG. 3 illustrates the anomaly detector being applied to a data sample during training or at test time. In particular, FIG. 3 shows a data sample 300, being in this example a spectrogram, as input. The data sample 300 may be transformed by respective data transformations 310-314, yielding a respective number of transformed data samples 320-324. It is noted that the transformed data samples are shown merely symbolically in FIG. 3 and are therefore not representative of the actual output of the data transformations 310-314. The data sample 300 and the transformed data samples 320-324 may be input into a feature extractor 330, which may generate feature representations 340 of the data samples, e.g., one feature representation for each data sample. It is noted that the feature representations are also shown symbolically in FIG. 3 and are therefore not representative of actual feature representations. Based on the feature representations, the training objective may be evaluated. The training objective may in general reward a similarity 350 between the feature representation of the respective transformed data sample and the feature representation of the input data sample, and a dissimilarity 360 between the feature representation of the respective transformed data sample and the feature representations of other transformed data samples generated from the input data sample. For example, when using the contrastive loss of eq. 2 as the training objective, the numerator of the contrastive loss may encourage the feature representations of the transformed data samples to align in the feature space with that of the original data sample (similarity), while the denominator pushes the feature representations in the feature space apart from each other (dissimilarity).

Anomaly Score. The evaluation of the deterministic contrastive loss may comprise determining an anomaly score for an input data sample. Namely, the contrastive objective from eq. (2) may represent an anomaly scoring function S(x):

$$S ( x ) = {\sum }_{k = 1}^{K} log \frac{h ( {x}_{k} , x )}{h ( {x}_{k} , x ) + {\sum }_{l \neq k} h ( {x}_{k} , {x}_{i} )} . \qquad ( 3 )$$

This anomaly scoring function may yield a higher score if an input data sample is less likely to be an anomaly and a lower score if an input data sample is more likely to be an anomaly. Since the score is deterministic, it may be straightforwardly evaluated at test time for new data samples x without the need for negative samples.

With continued reference to the anomaly detector and its embodiments, to learn data transformations for self-supervised anomaly detection, two requirements are formulated which provide a basis for the anomaly detector described in this specification:

Req. 1 (Semantics) The data transformations should produce transformed data samples that share relevant semantic information with the input data sample.

Req. 2 (Diversity) The data transformations should produce diverse transformations of each input data sample.

A valid loss function for learning the anomaly detector should avoid solutions that violate either of these requirements. There are numerous transformations that would violate req. 1 or req. 2. For example, a constant transformation Tₖ(x)=cₖ, where cₖ is a constant that does not depend on x, would violate the semantic requirement, whereas the identity T₁(x)= . . . =T_{K}(x)=x violates the diversity requirement. It is thus noted that for self-supervised anomaly detection, the learned data transformations need to negotiate the trade-off between semantics and diversity, with the above two examples being edge-cases on a spectrum of possibilities. Without semantics, i.e., without dependence on the input data sample, an anomaly detection method may not decide whether a new data sample is normal or an anomaly, while without variability in learning transformations, the self-supervised learning goal is not met. The contrastive loss of eq. (2) negotiates this trade-off since its numerator encourages transformed data samples to resemble the input data sample (i.e., the semantic requirement) and the denominator encourages the diversity of transformations. The contrastive loss thus incorporates a well-balanced objective which encourages a heterogeneous set of data transformations that model various relevant aspects of the training data. Using the contrastive loss, the data transformations and the feature extractor may be trained to highlight salient features of the data such that a low loss can be achieved. After training, samples from the data class represented by the training data have a high anomaly score according to eq. (3), while anomalies will result in a low anomaly score.

FIGS. 4A-4B show empirical evidence for the above, showing histograms of anomaly scores computed using eq. (3).

Specifically, along the horizontal axis, the anomaly score 410 is depicted (with a negative sign, meaning a score towards zero indicates more ‘normal’ data), while the vertical axis sets out the density 420. FIG. 4A shows that, before training, the histogram of anomaly scores is similar for inliers 430 and anomalies 440, while FIG. 4B shows that after training, inliers and anomalies become easily distinguishable.

Another advantage of using the contrastive objective/anomaly scoring function according to eq. (3) for self-supervised anomaly detection is that, unlike most other contrastive objectives, the “negative samples” are not drawn from a noise distribution (e.g., other samples in the minibatch) but constructed deterministically from x. Dependence on the minibatch for negative samples would need to be accounted for at test time. In contrast, the deterministic nature of eq. (3) makes it a simple choice for anomaly detection.

By being able to learn the data transformations, the anomaly detector may be applied to various types of data samples, including but not limited to data timeseries and tabular data, which may be important in many application domains of anomaly detection.

Evaluation. The anomaly detector described in this specification may be compared to prevalent shallow and deep anomaly detectors using two evaluation protocols: the ‘one-vs.-rest’ and the more challenging ‘n-vs.-rest’ evaluation protocol. Both settings turn a classification dataset into a quantifiable anomaly-detection benchmark.

one-vs-rest. For ‘one-vs.-rest’, a given dataset is split by the N class labels, creating N one class classification tasks; the anomaly detectors are trained on data from one class and tested on a test set with examples from all classes. The samples from other classes should be detected as anomalies.

n-vs-rest. In the more challenging n-vs.-rest protocol, n classes (for 1≤n<N) are treated as normal and the remaining classes provide the anomalies in the test and validation set. By increasing the variability of what is considered normal data, one-class classification becomes more challenging.

The performance of the anomaly detector described in this specification is compared to a number of unsupervised and self-supervised anomaly detectors. For that purpose, the learnable data transformations and the feature extractor are implemented as neural networks, with the resulting anomaly detector being also referred to as ‘NTL AD’ or ‘NeuTraL AD’, both referring to ‘neural transformation learning for anomaly detection’.

Three popular anomaly detectors where chosen: OC-SVM, a kernel-based detector, IF, a tree-based model which aims to isolate anomalies, and LOF, which uses density estimation with k-nearest neighbors. Furthermore, two deep anomaly detectors were included, Deep-SVDD, which fits a one-class SVM in the feature space of a neural net, and DAGMM, which estimates the density in the latent space of an autoencoder. Furthermore, a self-supervised anomaly detector, which may technically also be a deep anomaly detector, is included: GOAD is a distance-based classification method based on random affine transformations. Finally, two anomaly detectors were included that are specifically designed for time series data: The RNN directly models the data distribution and uses the log-likelihood as the anomaly score, while LSTM-ED is an encoder-decoder time-series anomaly detector where anomaly score is based on the reconstruction error.

Anomaly Detection of Time Series. The anomaly detector as described in this specification may be applied to a data timeseries as a whole. This may for example allow detection of abnormal sounds or to find production quality issues by detecting abnormal sensor measurements recorded over the duration of producing a batch. Other applications are sports and health monitoring; an abnormal movement pattern during sports may be indicative of fatigue or injury, whereas anomalies in health data can point to more serious issues. The performance of the anomaly detector is evaluated on a selection of datasets that are representative of these varying domains. The datasets come from the UEA multivariate time series classification archive (http://www.timeseriesclassification.com/, https://arxiv.org/abs/1811.00075) and include the so-called SAD (SpokenArabicDigits), NATOPS, CT (CharacterTrajectories), Epilepsy and RS (RacketSports) datasets.

The anomaly detector as described in this specification (‘NTL AD’ or ‘NeuTraL AD’) is described to the references under the one-vs-rest setting. Additionally, it is studied how the different anomaly detectors adapt to increased variability of inliers by exploring SAD and NATOPS under the n-vs-rest setting for varying number of classes n considered normal.

Test implementation Details. The learnable transformations of the ‘NeuTraL AD’ anomaly detector are multiplicatively Tₖ(x)=Mₖ(x)⊙x (elementwise multiplication). The masks Mₖ are each a stack of three residual blocks with instance normalization layers plus one convolutional layer with sigmoid activation function. All bias terms are zero. For a fair comparison, the same number of 12 transformations is used in NeuTraL AD, GOAD, and the classification based method (‘fixed T’) for which appropriate transformations where manually designed. The same encoder architecture is used for NeuTraL AD, Deep-SVDD and with slight modification to achieve the appropriate number of outputs for DAGMM and transformation prediction with fixed T. The feature extractor is a stack of residual blocks of 1d convolutional layers. The number of blocks depends on the dimensionality of the input data. The feature extractor has output dimension 64 for all experiments.

Results. The results of NeuTraL AD in comparison to the reference anomaly detectors on time series datasets from various fields are reported in Table 1 shown below.

TABLE 1
Average AUC with standard deviation for one-vs-rest anomaly detection on time series datasets.

| | OCSVM | IF | LOF | RNN | LSTM | SVDD | DAGMM | GOAD | FIXED TS | NTL-AD |
|---|---|---|---|---|---|---|---|---|---|---|
| SAD | 95.3 | 88.2 | 98.3 | 81.5 ± 0.4 | 93.1 ± 0.5 | 86.0 ± 0.1 | 80.9 ± 1.2 | 94.7 ± 0.1 | 96.7 ± 0.1 | 98.9 ± 0.1 |
| NATOPS | 86.0 | 85.4 | 89.2 | 89.5 ± 0.4 | 91.5 ± 0.3 | 88.6 ± 0.8 | 78.9 ± 3.2 | 87.1 ± 1.1 | 78.4 ± 0.4 | 94.5 ± 0.8 |
| CT | 97.4 | 94.3 | 97.8 | 96.3 ± 0.2 | 79.0 ± 1.1 | 95.7 ± 0.5 | 89.8 ± 0.7 | 97.7 ± 0.1 | 97.9 ± 0.1 | 99.3 ± 0.1 |
| Epilepsy | 61.1 | 67.7 | 56.1 | 80.4 ± 1.8 | 82.6 ± 1.7 | 57.6 ± 0.7 | 72.2 ± 1.6 | 76.7 ± 0.4 | 80.4 ± 2.2 | 92.6 ± 1.7 |
| RS | 70.0 | 69.3 | 57.4 | 84.7 ± 0.7 | 65.4 ± 2.1 | 77.4 ± 0.7 | 51.0 ± 4.2 | 79.9 ± 0.6 | 87.7 ± 0.8 | 86.5 ± 0.6 |

It can be seen that NeuTraL AD outperforms all shallow anomaly detectors in all experiments and outperforms the deep learning anomaly detectors in 4 out of 5 experiments. Only on the RS dataset, NeuTraL AD is outperformed by transformation prediction with fixed transformations, which was designed to understand the value of learning transformations with NeuTraL AD vs. using hand-crafted transformations. However, the hand-crafted transformations only succeed sometimes, e.g., in the RS dataset, whereas with NeuTraL AD the appropriate transformations can be learned in a systematic way.

The learned masks M_{1:4}(x) of one inlier x, being in this example a spectrogram from the SAD dataset, are visualized in FIG. 5. It can be seen that the four masks are dissimilar with each other and have learned to focus on different aspects of the spectrogram. The masks assume values between 0 and 1, with dark areas corresponding to values close to 0 that are zeroed out by the masks, while light colors correspond to the areas of the spectrogram that are not masked out. Interestingly, in M₁, M₂, and M₃ ‘black lines’ can be seen where entire frequency bands are masked out at least for part of the sequence. In contrast, M₄ has a bright spot in the middle left part; it creates data transformations that focus on the content of the intermediate frequencies at the first half of the recording.

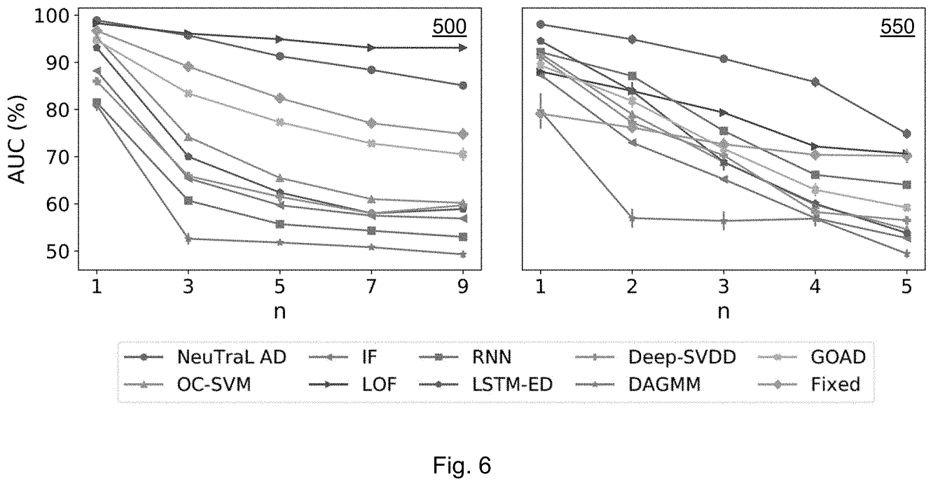

To empirically study how the anomaly detectors cope with an increased variability of inliers, all anomaly detectors were tested on the SAD and NATOPS datasets under the n-vs-rest setting with varying n. Since there are too many combinations of normal classes when n approaches N−1, only combinations of n consecutive classes were considered. From FIG. 6, one can observe that the performance of all anomaly detectors drops as the number of classes included in the normal data (i.e., the training data as inlier data) increases. This shows that the increased variance in the normal data makes the classification task more challenging. Still, NeuTraL AD outperforms all anomaly detectors on the NATOPS dataset and all deep-learning anomaly detectors on the SAD dataset.

Anomaly Detection of Tabular Data. Tabular data is another important application area of anomaly detection. For example, many types of heath data come in tabular form. Four tabular datasets from the empirical studies of Zong et al. “Deep Autoencoding Gaussian Mixture Model for Unsupervised Anomaly Detection,” 2018) and Bergman and Hoshen, “Classification-Based Anomaly Detection for General Data,” https://arxiv.org/abs/2005.02359). The datasets include the small-scale medical datasets Arrhythmia and Thyroid as well as the large-scale cyber intrusion detection datasets KDD and KDDRev. The configuration of Zong et al. was followed to train all detectors on half of the normal data, and test on the rest of the normal data as well as the anomalies.

NeuTraL AD was compared to shallow and deep baselines including OCSVM, IF, LOF, and the deep anomaly detection methods SVDD, DAGMM, and GOAD. The implementation details of OCSVM, LOF, DAGMM, and GOAD are replicated from Bergman and Hoshen. The learnable transformations are again parameterized multiplicatively Tₖ(x)=Mₖ(x)⊙x, with the masks Mₖ being comprised of 3 bias-free linear layers with intermediate ReLU activations and sigmoid activation for the output layer. The number of learnable transformations is 11 for Arrythmia, 4 for Thyroid, and 7 for KDD and KDDRev. A comparable encoder architecture was used for NeuTraL AD and SVDD of 3 (4 for KDD and KDDRev) linear layers with ReLU activations. The output dimensions of the encoder are 12 for Thyroid and 32 for the other datasets. The results of OCSVM, LOF, DAGMM, and GOAD are taken from Bergman and Hoshen. NeuTraL AD outperforms all other detectors on all datasets. Compared with the self-supervised anomaly detector GOAD, much fewer transformations were used, while early stopping was not needed in any of the experiments.

TABLE 2
F1-score with standard deviation for anomaly detection on tabular
datasets (choice of F1-score consistent with prior work)

| | Arrhythmia | Thyroid | KDD | KDDRev |
|---|---|---|---|---|
| OCSVM | 45.8 | 38.9 | 79.5 | 83.2 |
| IF | 57.4 | 46.9 | 90.7 | 90.6 |
| LOF | 50.0 | 52.7 | 83.8 | 81.6 |
| SVDD | 53.9 ± 3.1 | 70.8 ± 1.8 | 99.0 ± 0.1 | 98.6 ± 0.2 |
| DAGMM | 49.8 | 47.8 | 93.7 | 93.8 |
| GOAD | 52.0 ± 2.3 | 74.5 ± 1.1 | 98.4 ± 0.2 | 98.9 ± 0.3 |
| NeuTraL AD | 60.3 ± 1.1 | 76.8 ± 1.9 | 99.3 ± 0.1 | 99.1 ± 0.1 |

Design Choices for the Transformations. The performance of NeuTraL AD was studied under various design choices for the learnable data transformations, including their parametrization and the total number of data transformations K. The following parametrizations were considered: feed forward Tₖ(x):=Mₖ(x), residual Tₖ(x):=Mₖ(x)+x, and multiplicative Tₖ(x):=Mₖ(x)⊙x, which differ in how they combine the learnable transformations Mₖ(⋅) with the input data x. For large enough K, NeuTraL AD is found to be robust to the different parametrizations since the contrastive loss of eq. 2 ensures that the learned data transformations satisfy the semantic requirement and the diversity requirement. The performance of NeuTraL AD improves as the number K increases and becomes stable when K is large enough. When K≤4, the performance may have a larger variance since the learned transformations may not always be guaranteed to be useful for anomaly detection without the guidance of any labels. When K is large enough, e.g., 5, 6, 8, 10, 12, 14, 16, etc., the learned transformations contain with high likelihood transformations that are useful for anomaly detection. K may be a hyperparameter which may be optimized.

In general, the learnable functions of the anomaly detector, such as the learnable data transformations and the learnable feature extractor, may be based on neural networks. As such, a respective function may comprise or be comprised of a neural network. The neural network may comprise at least one of: one or more feedforward layers, one or more skip connections between layers, one or more convolutional layers, and a set of layers representing a transformer network. However, the learnable functions do not need to be based on neural networks as they may also be based on learnable affine transformations, learnable integral transformations with a kernel function, a learnable physical simulator, etc.

FIG. 7 shows a test system 600 for using a trained anomaly detector to distinguish outlier data from inlier data on which the anomaly detector is trained. The system 600 may comprise an input interface subsystem for accessing trained anomaly detector data 654 representing a trained anomaly detector as may be generated by the system 100 of FIG. 1 or the method 200 of FIG. 2 or as described elsewhere. The trained anomaly detector may for example comprise data representations of the set of learned data transformations, the learned feature extractor and the anomaly scoring function. For example, as also illustrated in FIG. 7, the input interface subsystem may comprise a data storage interface 640 which may access the trained anomaly detector data 654 from a data storage 650. In general, the data storage interface 640 and the data storage 650 may be of a same type as described with reference to FIG. 1 for the data storage interface 140 and the data storage 150. FIG. 7 further shows the data storage 650 comprising test data 652 comprising one or more test data samples. For example, the test data 652 may be or may comprise sensor data obtained from one or more sensors. In a specific example, the test data 652 may represent an output of a sensor-based observation, e.g., a sensor measurement, and the trained anomaly detector may classify respective data samples as normal or abnormal, i.e., anomalous. In some embodiments, the sensor data may also be received directly from a sensor 685, for example via a sensor data interface 660 or another type of interface instead of being accessed from the data storage 650. In such embodiments, the sensor data 662 may be received ‘live’, e.g., in real-time or pseudo real-time, by the test system 600. In such and other cases, the sensor data 662 may comprise or consist of time-sequential data.

The system 600 may further comprise a processor subsystem 620 which may be configured to, during operation of the system 600, apply the anomaly detector to a test data sample by, using the set of learned data transformations, generating, using the test data sample as input, a set of transformed data samples as output, and using the learned feature extractor, generating respective feature representations of the transformed data samples and of the test data sample. The processor subsystem 620 may be further configured to evaluate the anomaly scoring function using the feature representations to obtain an anomaly score. In some embodiments, the anomaly score may be thresholded determine whether or not the test data sample represents an outlier with respect to the inlier data on which the anomaly detector is trained. In other embodiments, the anomaly score may be used as-is, e.g., to obtain a probability that the test data sample is anomalous.

In general, the processor subsystem 620 may be configured to perform any of the functions as previously described with reference to FIGS. 3-6 and elsewhere. In particular, the processor subsystem 620 may be configured to apply a trained anomaly detector of a type as described with reference to the training of the anomaly detector. It will be appreciated that the same considerations and implementation options apply for the processor subsystem 620 of FIG. 7 as for the processor subsystem 120 of FIG. 1. It will be further appreciated that the same considerations and implementation options may in general apply to the system 600 as for the system 100 of FIG. 1, unless otherwise noted.

FIG. 7 further shows various optional components of the system 600. For example, in some embodiments, the system 600 may comprise a sensor data interface 660 for directly accessing sensor data 662 acquired by a sensor 685 in an environment 680. The sensor 685 may, but does not need to, be part of the system 600. The sensor 685 may have any suitable form, such as an image sensor, a temperature sensor, a radiation sensor, a proximity sensor, a pressure sensor, a medical sensor, a position sensor, a photoelectric sensor, a flow sensor, a contact sensor, a non-contact sensor, an electrical sensor, a particle sensor, a motion sensor, a level sensor, a leak sensor, a humidity sensor, a gas sensor, a force sensor, etc., or may comprise a combination of such and other types of sensors. The sensor data interface 660 may have any suitable form corresponding in type to the type of sensor(s), including but not limited to a low-level communication interface, an electronic bus, or a data storage interface of a type as described above for the data storage interface 640.

In some embodiments, the system 600 may comprise an output interface, such as an actuator interface 670 for providing control data 672 to an actuator 690 in the environment 680. Such control data 672 may be generated by the processor subsystem 620 to control the actuator 690 based on the anomaly score as generated by the trained anomaly detector when applied to the test data, or based on a thresholded version of the anomaly score. For example, the actuator 690 may be an electric, hydraulic, pneumatic, thermal, magnetic and/or mechanical actuator. Specific yet non-limiting examples include electrical motors, electroactive polymers, hydraulic cylinders, piezoelectric actuators, pneumatic actuators, servomechanisms, solenoids, stepper motors, etc. Thereby, the system 600 may take actions in response to a detection of an anomaly, e.g., to control a manufacturing process to discard a product or to adjust the manufacturing process, etc.

In other embodiments (not shown in FIG. 7), the system 600 may comprise an output interface to a rendering device, such as a display, a light source, a loudspeaker, a vibration motor, etc., which may be used to generate a sensory perceptible output signal which may be generated based on the anomaly score generated by the trained anomaly detector. The sensory perceptible output signal may be directly indicative of the anomaly score or an anomaly classification result derived from the anomaly score, e.g., by thresholding, but may also represent a derived sensory perceptible output signal. Using the rendering device, the system 600 may provide sensory perceptible feedback to a user, such as a health professional, a process operator, a data analyst, etc., of a detected anomaly.

In general, each system described in this specification, including but not limited to the system 100 of FIG. 1 and the system 600 of FIG. 7, may be embodied as, or in, a single device or apparatus, such as a workstation or a server. The device may be an embedded device. The device or apparatus may comprise one or more microprocessors which execute appropriate software. For example, the processor subsystem of the respective system may be embodied by a single Central Processing Unit (CPU), but also by a combination or system of such CPUs and/or other types of processing units. The software may have been downloaded and/or stored in a corresponding memory, e.g., a volatile memory such as RAM or a non-volatile memory such as Flash. Alternatively, the processor subsystem of the respective system may be implemented in the device or apparatus in the form of programmable logic, e.g., as a Field-Programmable Gate Array (FPGA). In general, each functional unit of the respective system may be implemented in the form of a circuit. The respective system may also be implemented in a distributed manner, e.g., involving different devices or apparatuses, such as distributed local or cloud-based servers. In some embodiments, the system 600 may be part of a control system configured to control a physical entity or a manufacturing process or may be part of a data analysis system.

FIG. 8 shows a computer-implemented method 700 using a trained anomaly detector to distinguish outlier data from inlier data on which the anomaly detector is trained. The method 700 may correspond to an operation of the system 600 of FIG. 7 but may also be performed using or by any other system, machine, apparatus or device. The computer-implemented method 700 is shown to comprise, in a step titled “OBTAINING TEST DATA”, obtaining 710 test data comprising one or more test data samples. The method 700 is further shown to comprise, in a step titled “OBTAINING DATA REPRESENTATION OF TRAINED ANOMALY DETECTOR”, obtaining 720 a trained anomaly detector as described elsewhere in this specification. The method 700 is further shown to comprise, in a step titled “ANOMALY DETECTION”, applying 730 the anomaly detector to a test data sample by, in a sub-step titled “USING LEARNED DATA TRANSFORMATIONS TO OBTAIN TRANSFORMED DATA”, using 740 the set of learned data transformations, generating, using the test data sample as input, a set of transformed data samples as output, in a sub-step titled “USING LEARNED FEATURE EXTRACTOR TO EXTRACT FEATURE REPRESENTATIONS”, using 750 the learned feature extractor, generating respective feature representations of the transformed data samples and of the test data sample, and in a sub-step titled “EVALUATING ANOMALY SCORE USING ANOMALY SCORING FUNCTION”, evaluating 760 the anomaly scoring function using the feature representations to obtain an anomaly score. In some embodiments, the evaluation may also comprise thresholding the anomaly score to determine whether or not the test data sample represents an outlier with respect to the inlier data on which the anomaly detector is trained (Y/N in FIG. 8). Other test data samples may be tested by repeated execution of sub-steps 740-760.

It will be appreciated that, in general, the operations or steps of the computer-implemented methods 200 and 700 of respectively FIGS. 2 and 8 may be performed in any suitable order, e.g., consecutively, simultaneously, or a combination thereof, subject to, where applicable, a particular order being necessitated, e.g., by input/output relations.

Each method, algorithm or pseudo-code described in this specification may be implemented on a computer as a computer implemented method, as dedicated hardware, or as a combination of both. As also illustrated in FIG. 9, instructions for the computer, e.g., executable code, may be stored on a computer-readable medium 800, e.g., in the form of a series 810 of machine-readable physical marks and/or as a series of elements having different electrical, e.g., magnetic, or optical properties or values. The executable code may be stored in a transitory or non-transitory manner. Examples of computer-readable mediums include memory devices, optical storage devices, integrated circuits, servers, online software, etc. FIG. 8 shows an optical disc 800. In an alternative embodiment of the computer-readable medium 800, the computer-readable medium may comprise trained anomaly detector data 810 defining a trained anomaly detector as described elsewhere in this specification, e.g., comprising data representations of the set of learned data transformations, the learned feature extractor and the anomaly scoring function.

Examples, embodiments or optional features, whether indicated as non-limiting or not, are not to be understood as limiting the present invention.

Mathematical symbols and notations are provided for facilitating the interpretation of the present invention and shall not be construed as limiting the present invention.

It should be noted that the above-mentioned embodiments illustrate rather than limit the present invention, and that those skilled in the art will be able to design many alternative embodiments without departing from the scope of the present invention. Use of the verb “comprise” and its conjugations does not exclude the presence of elements or stages other than those stated. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The present invention may be implemented by means of hardware comprising several distinct elements, and by means of a suitably programmed computer. In a device described as including several means, several of these means may be embodied by one and the same item of hardware. The mere fact that certain measures are described separately does not indicate that a combination of these measures cannot be used to advantage.

What is claimed is:

1. A computer-implemented method of training an anomaly detector to distinguish outlier data from inlier data on which the anomaly detector is trained, comprising:
providing training data, the training data comprising data samples;
providing an anomaly detector including:
a set of learnable data transformations, wherein each learnable data transformation of the learnable data transformations is at least in part parameterized and configured to transform a data sample into a transformed data sample in accordance with its parameterization,
a learnable feature extractor, wherein the learnable feature extractor is at least in part parameterized and configured to generate a feature representation from a data sample or a transformed data sample in accordance with its parametrization;
jointly training the set of learnable data transformations and the learnable feature extractor using the training data and a training objective, wherein the joint training includes, in a forward pass of the training:
using the set of learnable data transformations, generating, using an input data sample from the training data as input, a set of transformed data samples as output,
using the learnable feature extractor, generating respective feature representations of the transformed data samples and of the input data sample, and
evaluating the training objective using the feature representations, wherein the training objective is optimized by, for each transformed data sample, increasing:
a) a similarity between the feature representation of the respective transformed data sample and the feature representation of the input data sample, and
b) a dissimilarity between the feature representation of the respective transformed data sample and the feature representations of other transformed data samples generated from the input data sample; and
in a backward pass of the training, adjusting parameters of the learnable data transformations and the learnable feature extractor in dependence on the training objective.

2. The computer-implemented method according to claim 1, wherein the training objective includes a function which is to be optimized, wherein the function defines sums of pairwise similarities between feature representations to quantify:
a similarity between the feature representation of each respective transformed data sample and the feature representation of the input data sample; and
a similarity between the feature representation of each respective transformed data sample and the feature representations of the other transformed data samples generated from the input data sample.

3. The computer-implemented method according to claim 2, wherein the function is defined as:
$${\sum }_{k = 1}^{K} log \frac{h ( {x}_{k} , x )}{h ( {x}_{k} , x ) + {\sum }_{l \neq k} h ( {x}_{k} , {x}_{i} )}$$
where x represents the input data sample, xₖ represents a transformed data sample k from the set of K learnable data transformations, xₗ represents another transformed data sample with l unequal to k, and where function h quantifies a pairwise similarity.

4. The computer-implemented method according to claim 2, wherein the function is an anomaly scoring function generating an anomaly score for use:
during the training and as part of the training objective, wherein the training objective seeks to maximize the anomaly score for the training data; and
when using the anomaly detector after the training, to generate an anomaly score for a data sample which is provided as input to the anomaly detector.

5. The computer-implemented method according to claim 1, wherein each learnable data transformation includes a neural network.

6. The computer-implemented method according to claim 5, wherein the neural network includes at least one of:
one or more feedforward layers;
one or more skip connections between layers;
one or more convolutional layers;
a set of layers representing a transformer network.

7. The computer-implemented method according to claim 5, wherein the neural network is configured to generate the transformed data sample in form of an element-wise multiplication of:
the input data sample, with
an output of a feedforward network part receiving the input data sample as input.

8. The computer-implemented method according to claim 1, wherein the training data includes a number of data timeseries as respective data samples, and wherein each learnable data transformation is configured to transform a data timeseries into a transformed data timeseries in accordance with its parameterization.

9. The computer-implemented method according to claim 8, wherein the data timeseries includes a timeseries of sensor data.

10. The computer-implemented method according to claim 1,
wherein the training data includes tabular data defining a set of attributes for a respective data sample, and
wherein each learnable data transformation is configured to transform the set of attributes into a transformed set of attributes in accordance with its parameterization.

11. A non-transitory computer-readable medium on which is stored data representing a trained anomaly detector, the trained anomaly detector be trained to distinguish outlier data from inlier data on which the anomaly detector is trained, the trained anomaly detector having been trained by:
providing training data, the training data comprising data samples;
providing an anomaly detector including:
a set of learnable data transformations, wherein each learnable data transformation of the learnable data transformations is at least in part parameterized and configured to transform a data sample into a transformed data sample in accordance with its parameterization,
a learnable feature extractor, wherein the learnable feature extractor is at least in part parameterized and configured to generate a feature representation from a data sample or a transformed data sample in accordance with its parametrization;
jointly training the set of learnable data transformations and the learnable feature extractor using the training data and a training objective, wherein the joint training includes, in a forward pass of the training:
using the set of learnable data transformations, generating, using an input data sample from the training data as input, a set of transformed data samples as output,
using the learnable feature extractor, generating respective feature representations of the transformed data samples and of the input data sample, and
evaluating the training objective using the feature representations, wherein the training objective is optimized by, for each transformed data sample, increasing:
a) a similarity between the feature representation of the respective transformed data sample and the feature representation of the input data sample, and
b) a dissimilarity between the feature representation of the respective transformed data sample and the feature representations of other transformed data samples generated from the input data sample; and
in a backward pass of the training, adjusting parameters of the learnable data transformations and the learnable feature extractor in dependence on the training objective.

12. A computer-implemented method of using a trained anomaly detector to distinguish outlier data from inlier data on which the anomaly detector is trained, the method comprising the following steps:
obtaining test data, the test data including one or more test data samples;
obtaining an anomaly detector, wherein the anomaly detector includes:
a set of learned data transformations, wherein each learned data transformation of the learned data transformations is at least in part parameterized and configured to transform a data sample into a transformed data sample in accordance with its parameterization;
a learned feature extractor, wherein the learned feature extractor is at least in part parameterized and configured to generate a feature representation from a data sample or a transformed data sample in accordance with its parametrization;
an anomaly scoring function which is part of the training objective which is optimized during the training of the anomaly detector;
applying the anomaly detector to a test data sample of the test data samples by:
using the set of learned data transformations, generating, using the test data sample as input, a set of transformed data samples as output,
using the learned feature extractor, generating respective feature representations of the transformed data samples and of the test data sample, and
evaluating the anomaly scoring function using the feature representations to obtain an anomaly score, wherein the anomaly score is lower when:
a) a similarity between the feature representation of the respective transformed data sample and the feature representation of the input data sample is greater, and
b) a dissimilarity between the feature representation of the respective transformed data sample and the feature representations of other transformed data samples generated from the input data sample is greater.

13. The computer-implemented method according to claim 12, further comprising thresholding the anomaly score to determine whether or not the test data sample represents an outlier with respect to the inlier data on which the anomaly detector is trained.

14. A non-transitory computer-readable medium on which are stored instructions training an anomaly detector to distinguish outlier data from inlier data on which the anomaly detector is trained, the instructions, when executed by a processor system, causing the processor system to perform the following steps:
providing training data, the training data comprising data samples;
providing an anomaly detector including:
a set of learnable data transformations, wherein each learnable data transformation of the learnable data transformations is at least in part parameterized and configured to transform a data sample into a transformed data sample in accordance with its parameterization,
a learnable feature extractor, wherein the learnable feature extractor is at least in part parameterized and configured to generate a feature representation from a data sample or a transformed data sample in accordance with its parametrization;
jointly training the set of learnable data transformations and the learnable feature extractor using the training data and a training objective, wherein the joint training includes, in a forward pass of the training:
using the set of learnable data transformations, generating, using an input data sample from the training data as input, a set of transformed data samples as output,
using the learnable feature extractor, generating respective feature representations of the transformed data samples and of the input data sample, and
evaluating the training objective using the feature representations, wherein the training objective is optimized by, for each transformed data sample, increasing:
a) a similarity between the feature representation of the respective transformed data sample and the feature representation of the input data sample, and
b) a dissimilarity between the feature representation of the respective transformed data sample and the feature representations of other transformed data samples generated from the input data sample; and
in a backward pass of the training, adjusting parameters of the learnable data transformations and the learnable feature extractor in dependence on the training objective.

15. A training system configured to train an anomaly detector to distinguish outlier data from inlier data on which the anomaly detector is trained, comprising:
an input interface subsystem configured to access:
training data including data samples;
anomaly detector data representing an anomaly detector to be trained, the anomaly detector including:
a set of learnable data transformations, wherein each learnable data transformation of the learnable data transformations is at least in part parameterized and configured to transform a data sample into a transformed data sample in accordance with its parameterization,
a learnable feature extractor, wherein the learnable feature extractor is at least in part parameterized and configured to generate a feature representation from a data sample or a transformed data sample in accordance with its parametrization;
a processor subsystem configured to jointly train the set of learnable data transformations and the learnable feature extractor using the training data and a training objective, wherein the joint training includes, in a forward pass of the training:
using the set of learnable data transformations, generating, using an input data sample from the training data as input, a set of transformed data samples as output,
using the learnable feature extractor, generating respective feature representations of the transformed data samples and of the input data sample, and
evaluating the training objective using the feature representations, wherein the training objective is optimized by, for each transformed data sample, increasing:
a) a similarity between the feature representation of the respective transformed data sample and the feature representation of the input data sample, and
b) a dissimilarity between the feature representation of the respective transformed data sample and the feature representations of other transformed data samples generated from the input data sample; and
in a backward pass of the training, adjusting parameters of the learnable data transformations and the learnable feature extractor in dependence on the training objective.

16. A test system for using a trained anomaly detector to distinguish outlier data from inlier data on which the anomaly detector is trained, comprising:
an input interface subsystem configured to access:
test data including one or more test data samples,
an anomaly detector, wherein the anomaly detector includes:
a set of learned data transformations, wherein each learned data transformation of the learned data transformations is at least in part parameterized and configured to transform a data sample into a transformed data sample in accordance with its parameterization;
a learned feature extractor, wherein the learned feature extractor is at least in part parameterized and configured to generate a feature representation from a data sample or a transformed data sample in accordance with its parametrization;
an anomaly scoring function which is part of the training objective which is optimized during the training of the anomaly detector;
a processor subsystem configured to apply the anomaly detector to a test data sample by:
using the set of learned data transformations, generating, using the test data sample as input, a set of transformed data samples as output,
using the learned feature extractor, generating respective feature representations of the transformed data samples and of the test data sample, and
evaluating the anomaly scoring function using the feature representations to obtain an anomaly score, wherein the anomaly score is lower when:
a) a similarity between the feature representation of the respective transformed data sample and the feature representation of the input data sample is greater, and
b) a dissimilarity between the feature representation of the respective transformed data sample and the feature representations of other transformed data samples generated from the input data sample is greater.
